(19) United States
(12) Patent Application Publication
(10) Pub. No.: US 2005/0178631 A1
(43) Pub. Date: Aug. 18, 2005

(54) Attachment to a carrying strap

(75) Inventor: Timm J. Fenton, Califon, NJ (US)

Correspondence Address: BAKER & BOTTS, 30 ROCKEFELLER PLAZA, NEW YORK, NY, 10112, US

(73) Assignee: TUMI, INC., South Plainfield, NJ (US)

(21) Appl. No.: 10/780,352

(22) Filed: Feb. 17, 2004

(51) Int. Cl. B62J 11/00; B62J 9/00; B62J 7/00; B65D 33/10; B65D 33/14; A45C 3/00

(52) U.S. Cl. 190/109; 383/8; 383/11

(57) ABSTRACT

An attachment to a strap includes a first portion adapted to be connected to the strap, and a second portion adjacent to the first portion. In one aspect of the present invention, a magnet is attached to the first, the magnet being capable of removably securing the second portion to the first portion when the first and second portions are brought in proximity. In another aspect of the present invention, the first portion includes a recess, and when the first and second portions are brought in contact with each other, the second portion is at least partially disposed in the recess of the first portion such that the attachment has an approximately smooth exterior at the junction of the first and second portions.

### FIELD OF THE INVENTION

The present invention relates generally to travel baggage, and more particularly to an attachment to a carrying strap that makes carrying the baggage more comfortable and convenient for a user.

### BACKGROUND INFORMATION

Attachments to carrying straps for baggage are becoming more common today. Most travel bags include two carrying straps, and many also include a shoulder strap. In many instances manufacturers of baggage include a leather attachment or of another material stitched to one of the two carrying straps. A user is generally able to place the second carrying strap close to the first carrying strap, and then wrap the attachment around both. This is done in order to make carrying the bag more comfortable to a hand of the user. In many instances, the attachment is secured to itself by either two buttons or sometimes via a Velcro® -type connection.

Several problems exist with attachments of the prior art. The button or Velcro® connections can sometimes be too difficult for a user to disconnect. These connections can wear out or fail over time. Furthermore, when the attachment is secured to itself, the exterior of the attachment at that junction lacks a smooth exterior and as such does not provide the optimal grasping diameter or comfort to the user.

### SUMMARY OF THE INVENTION

One of the objects of the present invention is to overcome the aforementioned problems and deficiencies.

For example, in one exemplary embodiment of the present invention, an attachment to a strap includes a first portion adapted to be connected to the strap; a second portion adjacent to the first portion; and a magnet attached to the first portion, the magnet being capable of removably securing the second portion to the first portion when the first and second portions are brought in proximity.

In a second exemplary embodiment of the present invention, an attachment to a strap includes a first portion adapted to be connected to the strap, the first portion including a recess; a second portion adjacent to the first portion; and wherein when the first and second portions are brought in contact with each other, the second portion is at least partially disposed in the recess of the first portion such that the attachment has a substantially smooth exterior at the junction of the first and second portions.

In a third exemplary embodiment of the present invention, an attachment to a strap includes a first portion adapted to be connected to the strap; a second portion adjacent to the first portion; and a magnet attached to the first portion, the magnet being capable of removably securing the first portion to the second portion when the first and second portions are brought in proximity; wherein the first portion includes a recess, wherein when the first and second portions are brought in contact with each other, the second portion is at least partially disposed in the recess of the first portion such that the attachment has a substantially smooth exterior at the junction of the first and second portions.

### BRIEF DESCRIPTION OF THE DRAWINGS

FIG. 1 shows an isometric view of a first exemplary embodiment of an attachment to a strap according to the present invention.

FIG. 2 shows an isometric view of the first exemplary embodiment in a secured position.

FIG. 3 shows an isometric view of a second exemplary embodiment of an attachment to a strap according to the present invention.

FIG. 4A shows an isometric view of the second exemplary embodiment in a secured position.

FIG. 4B shows a side view of the second exemplary embodiment in a secured position.

FIG. 5 shows an isometric view of the third exemplary embodiment of an attachment to a strap according to the present invention in a secured position.

FIG. 6 shows the first exemplary embodiment attached to a bag for holding articles in accordance with another exemplary embodiment of the present invention.

Throughout the figures, the same reference numerals and characters, unless otherwise stated, are used to denote like features, elements, components or portions of the illustrated embodiments. Moreover, while the present invention will now be described in detail with reference to the figures, it is done so in connection with the illustrative embodiments.

### DETAILED DESCRIPTION OF PREFERRED EMBODIMENTS

FIG. 1 depicts a first exemplary embodiment according to the present invention. An attachment 10 to a strap 30 includes a first portion 20 which may be adapted to be connected to the strap 30. The attachment 10 may be fabricated from leather, for example. The attachment 10 may include a plurality of layers and may be stitched to the strap 30. The strap 30 may be located between the layers of the attachment 10 or may be attached on an interior or exterior side thereof. A second portion 22 may be adjacent to the first portion 20. The first portion 20 may include a first area 21 and a further area 24. A magnet 26 may be attached to the further area 24. The magnet 26 may be imbedded in between an interior and exterior layer of the attachment 10, for example. A corresponding further magnet 28 or magnetic material (i.e., material that is attracted to a magnet) may be attached similarly to the second portion 22. If a magnet is attached to the second portion 22, a magnetic material may be attached to the first portion 20.

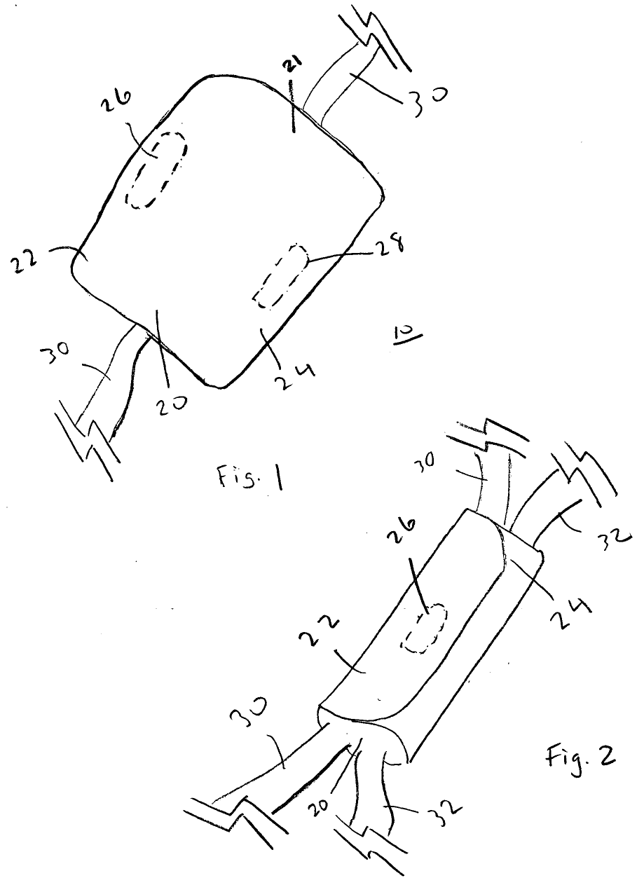

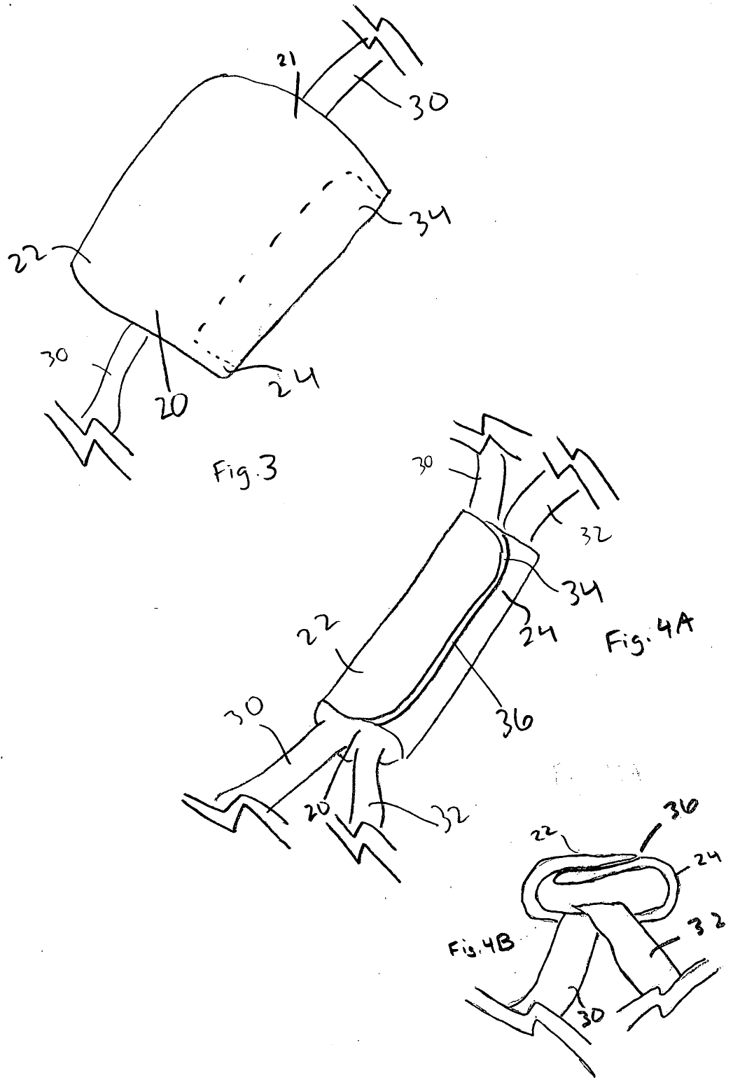

FIG. 2 depicts the first exemplary embodiment according to the present invention in a secured position. In this view, a further strap 32 may be brought close to the strap 30. A user may then secure the attachment around both straps 30, 32 by bringing the second portion 22 and the further area 24 in proximity with each other. The attachment may be secured to itself because the magnet 26 of the second portion 22 may be in communication with the corresponding further magnet 28 or the magnetic material suitably positioned in the further area 24.

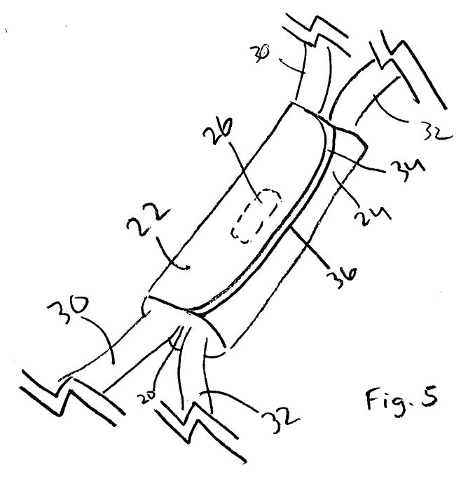

FIG. 3 depicts a second exemplary embodiment according to the present invention. An attachment 10 to a strap 30 includes a first portion 20 which may be adapted to be connected to the strap 30. The attachment 10 may be fabricated from leather, for example. The attachment 10 may include a plurality of layers and may be stitched to the strap 30. The strap 30 may be located between the layers of the attachment 10 or may be attached on an interior or exterior side thereof. A second portion 22 may be adjacent to the first portion 20. The first portion 20 may include a first area 21 and a further area 24. The further area 24 may include a recess 34 on an exterior side. The depth of the recess 34 may be such that when the second portion 22 and the further area 24 are brought in contact with each other, the second portion 22 sits or at least partially resides in the recess 34 of the further area 24 such that the attachment 10 has a substantially smooth exterior at the junction 36 of the second portion 22 and further area 24, as depicted in FIG. 4A, which depicts the second exemplary embodiment in a secured position. In this view, a further strap 32 may be brought close to the strap 30. A user may then secure the attachment 10 around both straps 30, 32 by bringing the second portion 22 and the further area 24 in proximity with each other. The method for securing the attachment in this embodiment may be with buttons or Velcro® (neither shown). Further, merely the memory of the material used as the attachment 10 or the way the material is stitched or cut may keep or assist keeping the attachment harnessed in the secured position.

FIG. 4B depicts a side view of FIG. 4A.

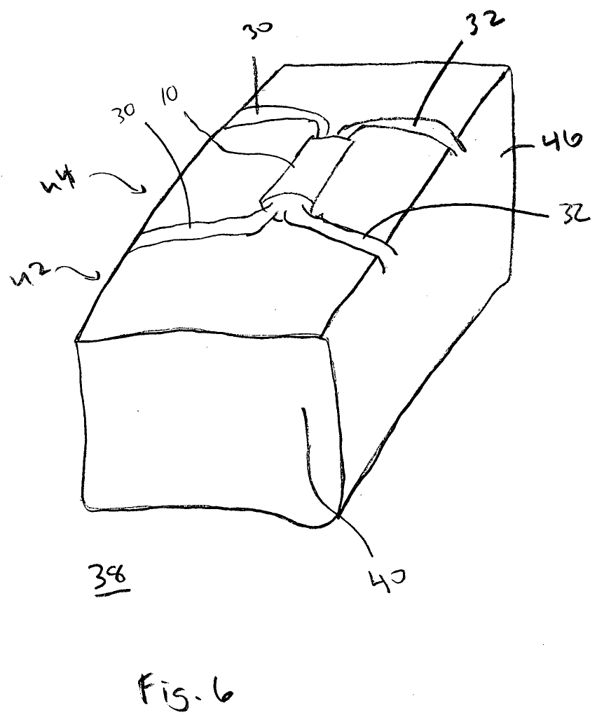

FIG. 5 depicts a third exemplary embodiment according to the present invention. FIG. 5 includes a combination of certain features shown in FIGS. 2 and 4. That is, the magnet 26 of FIG. 2 is used to secure the attachment to itself, but in addition, when the second portion 22 and further area 24 are placed in contact with each other, the second portion 22 sits or at least partially resides in a recess 34 in the further area 24, as it does in FIG. 4.

FIG. 6 shows the straps 30 and 32 attached to a bag 38. The bag 38, which can be, among other things, an overnight bag, a gym bag, a carrying case, a computer case or a pocket book, typically has a closeable compartment 40. One or more walls 42 may be used to form the compartment 40. Often but not always the bag 38 will be closeable by a zipper arrangement (not shown) or some other arrangement between a first 44 and second 46 side or wall of the bag 38 with one of the straps 30, 32 attached to the first side or wall 44 of the bag 38 and the other strap 30 or 32 attached to the second side or wall 46 of the bag. In FIG. 6, the attachment 10 is shown in its secured position.

The foregoing merely illustrates the principles of the invention. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the invention and are thus within the spirit and scope of the invention.

1. An attachment to a strap comprising:
(a) a first portion adapted to be connected to the strap;
(b) a second portion adjacent to the first portion; and
(c) a magnet attached to the first portion, the magnet being capable of removably securing the second portion to the first portion when the first and second portions are brought in proximity.

2. The attachment of claim 1, wherein the first portion includes a recess, and wherein when the first and second portions are brought in contact with each other, the second portion is at least partially disposed in the recess of the first portion such that the attachment has a substantially smooth exterior at the junction of the first and second portions.

3. The attachment of claim 2, wherein the magnet is embedded in the first portion.

4. The attachment of claim 1, wherein the second portion has a recess, and wherein when the first and second portions are brought in contact with each other, the first portion is at least partially disposed in the recess of the second portion such that the attachment has a substantially smooth exterior at the junction of the first and second portions.

5. The attachment of claim 1, wherein the attachment is capable of retaining a further strap when the first and second portions are brought in contact with each other.

6. The attachment of claim 1, wherein the second portion has one of a further magnet and a magnetic material attached thereto adapted to communicate with the magnet attached to the first portion when the first and second portions are brought in proximity.

7. The attachment of claim 6, wherein one of the further magnet and the magnetic material is embedded in the second portion.

8. The attachment of claim 1, wherein:
(a) the first portion has a recess;
(b) the magnet is embedded in the first portion;
(c) the second portion has a further magnet embedded therein adapted to communicate with the magnet of first portion when the first and second portions are brought in proximity; and
(d) when the first and second portions are brought in contact with each other, the second portion is at least partially disposed in the recess of the first portion such that the attachment has a substantially smooth exterior at the junction of the first and second portions and the attachment is capable of retaining a further strap.

9. An attachment to a strap comprising:
(a) a first portion adapted to be connected to the strap, the first portion having a recess; and
(b) a second portion adjacent to the first portion;
(c) wherein when the first and second portions are brought in contact with each other, the second portion is at least partially disposed in the recess of the first portion such that the attachment has a substantially smooth exterior at the junction of the first and second portions.

10. The attachment of claim 9 wherein the attachment is capable of retaining a further strap when the first and second portions are brought in contact with each other.

11. A bag for holding articles comprising:
(a) at least one wall forming a compartment;
(b) a strap attached to the at least one wall; and
(c) an attachment to the strap comprising:
(i) a first portion adapted to be connected to the strap;
(ii) a second portion adjacent to the first portion; and
(iii) a magnet attached to the first portion, the magnet being capable of removeably securing the first portion to the second portion when the first and second portions are brought in proximity.

12. The bag of claim 11, wherein the first portion includes a recess, and wherein when the first and second portions are brought in contact with each other, the second portion is at least partially disposed in the recess of the first portion such that the attachment has a substantially smooth exterior at the junction of the first and second portions.

13. The bag of claim 12, wherein the magnet is embedded in the first portion.

14. The bag of claim 11, wherein the second portion includes a recess, and wherein when the first and second portions are brought in contact with each other, the first portion is at least partially disposed in the recess of the second portion such that the attachment has a substantially smooth exterior at the junction of the first and second portions.

15. The bag of claim 11, wherein the attachment is capable of retaining a further strap when the first and second portions are brought in contact with each other.

16. The bag of claim 11, wherein the second portion has one of a further magnet and a magnetic material attached thereto adapted to communicate with the magnet of the first portion when the first and second portions are brought in proximity.

17. The bag of claim 16, wherein one of the further magnet and the magnetic material is embedded in the second portion.

18. The bag of claim 11, wherein:
(a) the first portion has a recess;
(b) the magnet is embedded in the first portion;
(c) the second portion has a further magnet embedded therein adapted to communicate with the magnet the first portion when the first and second portions are brought in proximity; and
(d) when the first and second portions are brought in contact with each other, the second portion is at least partially disposed in the recess of the first portion such that the attachment has a substantially smooth exterior at the junction of the first and second portions and attachment is capable of retaining a further strap.

19. A bag for holding articles comprising:
(a) at least one wall forming a compartment;
(b) a strap attached to the at least one wall; and
(c) an attachment to the strap comprising:
(i) a first portion adapted to be connected to the strap, the first portion having a recess; and
(ii) a second portion adjacent to the first portion;
(iii) wherein when the first and second portions are brought in contact with each other, the second portion is at least partially disposed in the recess of the first portion such that the attachment has a substantially smooth exterior at the junction of the first and second portions.

20. The bag of claim 19 wherein the attachment is capable of retaining a further strap when the first and second portions are brought in contact with each other.
